(19) United States
(12) Patent Application Publication
(10) Pub. No.: US 2025/0012943 A1
(43) Pub. Date: Jan. 9, 2025

(54) THIN PERMEABLE LAYERS INDICATOR (TPLI) IN GEOLOGICAL FORMATIONS

(71) Applicant: Saudi Arabian Oil Company, Dhahran (SA)

(72) Inventors: Mohd Azizi Ibrahim, Dhahran (SA); Hussain Mufarah Alqahtani, Dhahran (SA); Faisal Naif Al-Enezi, Dhahran (SA)

(21) Appl. No.: 18/348,942

(22) Filed: Jul. 7, 2023

(51) Int. Cl. G01V 1/50

(52) U.S. Cl. CPC G01V 1/50

(57) ABSTRACT

Systems and methods include a computer-implemented method for identifying productive reservoir layers. Model input data from an exploration and producing (E&P) database is parameterized by identifying numerical relationships between qualitative model input data and dynamic model qualification data. Execution results from executing five model methodologies are combined using the parameterized model input data: a multimineral (MM) petrophysical evaluation model, a nuclear magnetic resonance (NMR) model, a shaly sand analysis model, a resistivity image log analysis model, and a neutron spectroscopy for rock quality indices model. Productive reservoir layers are identified by integrating outputs of the five model methodologies. Geosteering, while drilling in layers, is restricted to the identified productive reservoir layers.

### TECHNICAL FIELD

The present disclosure applies to identifying layers in geological formations.

### BACKGROUND

Many geological factors of deep tight reservoirs can influence completion performance, reservoir quality, and productivity along vertical and horizontal wells. Research and studies in this area have considered the problem of landing a horizontal well in a sweet spot to enhance the well performance. The quality of reservoirs can be benchmarked against formation test results and well completion performance. Geological databases and descriptions can be integrated with data analysis and used in validation processes.

### SUMMARY

The present disclosure describes techniques that can be used for identifying permeable thin layers in tight massive and shaly clastic formations. In some implementations, a petrophysical workflow can be used that combines standard logging data, neutron spectroscopy, advanced mud logging, advanced statistic and deterministic petrophysical analysis (e.g., using petrophysical software), nuclear magnetic resonance, and image log interpretations. The petrophysical workflow can combine and analyze data from the independent data sources to identify and provide critical sandstone reservoir properties related to hydrocarbon reservoir classification, quality, and productivity. Combining data from different sources can be done by matching layers identified from the different layers.

In some implementations, a computer-implemented method includes the following. Model input data is accessed from an exploration and producing (E&P) database. The model input data is parameterized by identifying numerical relationships between qualitative model input data and dynamic model qualification data. Execution results from executing five model methodologies are combined using the parameterized model input data. A multimineral (MM) petrophysical evaluation model is executed, the executing resulting in providing calibrated values for porosity, water saturation, intrinsic permeability, and mineral volumes. A nuclear magnetic resonance (NMR) model is executed using at least outputs of the MM petrophysical evaluation model, the executing resulting in generating porosity arrays from multiple Time 1 (T1) and Time 2 (T2) spectrums estimated using multiple bound fluid cutoffs. A shaly sand analysis model is executed using at least outputs of the MM petrophysical evaluation model and siltstone to matrix percentages, the executing resulting in including identifying productive layers. A resistivity image log analysis model is executed using layering from resistivity images, the executing resulting in determining layer thicknesses and depths. A neutron spectroscopy for rock quality indices model is executed, the executing resulting in determining reservoir quality from ratios of measured elements determined from spectrometry. Productive reservoir layers are identified by integrating outputs of the five model methodologies. Geosteering, while drilling in layers, is restricted to the identified productive reservoir layers.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. First, the success rate of producing from complex sandstone reservoirs can be improved due to: well placement that is not porosity dependent, optimized well placement in effective reservoirs, mapping of effective reservoirs for well placement planning, minimizing overall well costs, improved recovery factors, even distribution of hydrocarbon drainage, reduced numbers of required development wells, an expedited completion design stage, maximized hydrocarbon production rates, acquisition of more dynamic data for future planning from productive layers, and guiding well placement to maximize reservoir contact in complex tight reservoirs. Second, high success probability areas in a field can be identified for drilling future wells. Third, high-success probability completion intervals can be identified that are designed specifically for targeting hydrocarbon productive zones in ambiguous formations. Fourth, effective reservoir properties can be mapped to geological maps for performing future well planning. Fifth, machine learning can be used in completion design while assessing multiple independent metrics for zone selection. Sixth, continuous evaluation can occur for individual measurements or combinations of the measurements and interpretations thereof. The continuous evaluation can support real-time evaluation and decision-making, including providing drill-down and drill-up capabilities (e.g., through details evaluation in evaluation wells). Seventh, workflows of the present disclosure can be tested using evaluation wells, well-landing, geosteering, properties-mapping, and well completion plans. This can be done without requiring that all logs are available at the same time, especially in areas where calibrated data is available. Eighth, techniques of the present disclosure can be porosity independent, so that errors in porosity measurements have negligible impacts on final results. Ninth, techniques of the present disclosure can incorporate information from mineral ratios, chemical index ratios (CIR), and weathering index (WI). The techniques can use X-ray diffraction (XRD), X-ray fluorescence (XRF), and neutron spectroscopy logs data to validate the layers identified by the five techniques described in the present disclosure. The techniques include: multimin analysis, nuclear magnetic resonance (NMR) bound fluid analysis, NMR shaly sand analysis, standard logs shaly sand interpretation, and image log. Partial combinations can also be tested after calibration. The use of pattern recognition and/or artificial intelligent software can reduce requirements for log data acquisition, which can lead to significant cost reductions.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a diagram showing elements of an example workflow for implementing parameters in real-time based on identified permeable thin layers, according to some implementations of the present disclosure.

FIG. 2 is a graph showing comparison plots associated with multiple methodologies relative to depth and their indications of reservoir quality, according to some implementations of the present disclosure.

FIG. 3 is a flowchart showing an example of a method for identifying permeable thin layers, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques to identify permeable thin layers in tight massive and shaly clastic formations. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Techniques of the present disclosure include the use of a workflow process that considers raw and analyzed independent log data types and models. The workflow can provide petrophysical parameters indicating and estimating reservoir quality and productivity that are related to each data type from static and dynamic perspectives. Insights from these relationships can then guide in determining target production layers for (but not limited to) geo-steering, pressure and sampling data acquisition, well testing, and well completion.

The techniques of the present disclosure can be used for conventional and unconventional reservoirs where conventional log analysis cannot distinguish between productive and non-productive layers, e.g., due to geological complexity. The high-resolution image logs and neutron spectroscopy data can also improve predictions about layer thickness and rock quality. In some sandstone reservoirs, for example, conventional log analysis displays common values across the entire target interval without contrast between productive and non-productive data. Dynamic tests, core plug analysis, and completion results can show that a portion of reservoir layers contribute to the majority of flow in some complex sandstone reservoirs with high or low (e.g., below 5% effective) porosity.

The techniques of the present disclosure can be used to find the most productive reservoir layers by integrating multiple types of input that require standard logging data, neutron spectroscopy, advanced mud logging, advanced statistic and deterministic petrophysical analysis, nuclear magnetic resonance, and image log interpretation. Each of these can independently (or in combination) provide insight to critical sandstone reservoir properties related to hydrocarbon reservoir classification, quality, and productivity of the most productive layers without coring the formation.

In some implementations, to develop the techniques of the present disclosure, historical information can be analyzed that is associated with deep tight reservoirs and their completion performance and reservoir quality along vertical and horizontal wells that have influenced productivity. The analysis can include instances in which landings occurred in horizontal wells at sweet spots, resulting in improvements in the well performance. The quality of reservoirs can be benchmarked against formation test results and well completion performance. Geological databases and descriptions can be integrated with data analysis. In addition, well completion and performance data can be used as part of a validation process to verify techniques of the present disclosure. Based on the results, multiple parameters can be tested and implemented into drilling operations methodologies. Models can be implemented and executed that use static and dynamic information in terms of quality and quantity.

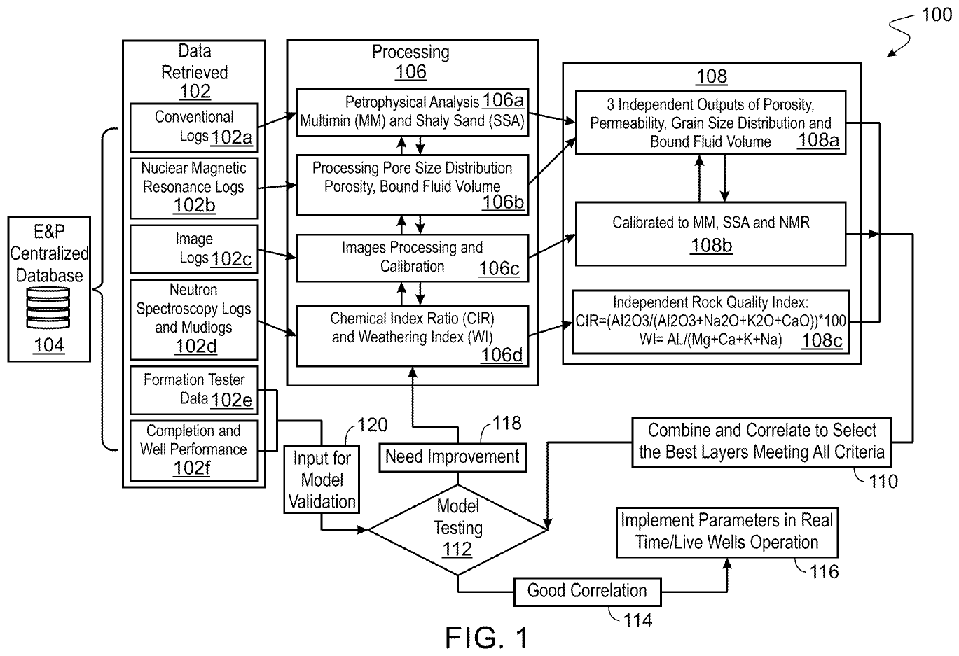

FIG. 1 is a diagram showing elements of an example workflow 100 for implementing parameters in real-time based on identified permeable thin layers, according to some implementations of the present disclosure. The workflow 100 can serve as an independent method for verification of clastic reservoir productivity, for example. At 102, relevant data 102a-102f is retrieved from a centralized E&P database 104. The data can include, for example, conventional logs 102a, nuclear magnetic resonance logs 102b, image logs 102c, neutron spectroscopy logs and mud logs 102d, formation tester data 102e, and completion and well performance data 102f. Formation tester data 102e and completion and well performance data 102f can serve as inputs 120 for model validation and used in model testing 112. In some implementations, to ensure consistency and accuracy relevant data of model input retrieved from the database can be downloaded and go through general quality assurance and quality control (QA/QC) processes. Sub-steps 102a and 102b are steps for validating log data by comparing the log data to environmental data. Substep 102c provides a comparison to core and geological features. In substep 102d, mineralogy and other forms of data (e.g., South Greenland Rise (SGR) core data) can be compared to the conventional core and special core analysis. In sub-step 102e, valid data with stabilized pressures less than 0.5 pounds per square inch (psi)/minute and repeatable measurements can be identified for utilization during processing. In subs-step 102f, data from specific perforations and/or from production logging tools (PLTs) can be used to verify the zone contribution. Sub-steps 102e and 102f can be used to verify identified zones that are predicted as zones of contribution.

In some implementations, image logs can be processed by zones as selected by sedimentologists or as correlated by shaly sand packages. Zonation of facies/depositional/rock typing and depositional environments can be based on sedimentologist inputs. Resistivity ranges can be correlated to lithology (e.g., sand, silt, or shale). An image can be reprocessed using the previously mentioned resistivity ranges for developing reservoir layers image (e.g., image log analysis 206).

Nuclear magnetic resonance (NMR) processing can occur using multiple bound fluid cutoffs and can be correlated to X-ray diffraction (XRD), X-ray fluorescence (XRF), and shaly sand analysis in order to more accurately identify volumes for sand, silt, and clay. Reasons for incorporating image logs include improving the ability to refine vertical resolutions and to identify thin layers that cannot be determined better (e.g., at better resolutions) by other logging tools.

At 106, processing of the data occurs, including parameterization of qualitative data, resulting in model inputs 108. Parameterization is needed, for example, because the model input data type is numerical and qualitative, such as the fraction of siltstone present in sandstone layers. The cutoff for an amount of siltstone that will classify a zone as productive or otherwise can be based on field and reservoir available data without specific cutoffs. The cutoff is subjective and can vary between fields. Methodologies of the present disclosure can be used to parameterize multiple independent qualitative data types to enable identify productive reservoir layers using numerical calculations performed on qualitative data. This can be done by identifying numerical relationships between qualitative model input and dynamic model qualification data. For example, a zone with reservoir quality indicators (e.g., for chemical index ratio (CIR) and weathering index (WI)) above 70 can be correlated as indicating a flowing permeability that enables fluid sampling and injectivity for fracking. The processing at 106 can include petrophysical analysis 106a, including multimin (MM) analysis and shaly sand (SSA) analysis; processing 106b of pore size distribution porosity and bound fluid volume, image processing, and calibration 106c; and CIR and WI analysis 106d. The model inputs 108 can include three independent outputs 108a of porosity, permeability, and grain size distribution and bound fluid volume; calibration 108b to MM, SA, and NMR; and independent rock quality indexes 108c for CIR and WI (e.g., scaled from 0 to 100.

At 110, the model inputs 108 are combined and correlated for model testing 112, including execution of the five models. If a good correlation 114 is determined to have occurred, then, at 116, the parameters are implemented in real-time/live well operations. If, at 118, it is determined that the improvement of the models' performance is needed, then the processing at 106 and subsequent steps can be repeated.

Image data processing can be used to further define the thickness and depth of targeted thin layers. The processing can use core and mud log information for calibration. Nuclear magnetic resonance (NMR) processing can be used to identify the grain size distribution and to indicate movable versus non-movable fluid volume. Image logs can provide layer information that, combined with NMR, can be used to provide an estimation of movable and non-movable fluid percentages for a zone of interest.

When methodologies of the five model inputs 108 are combined, each individual methodology is capable, on its own, of increasing the chances of success of identifying productive layers. As a result, combining the five independent methodologies together leads to targeting productive layers with an improved success rate.

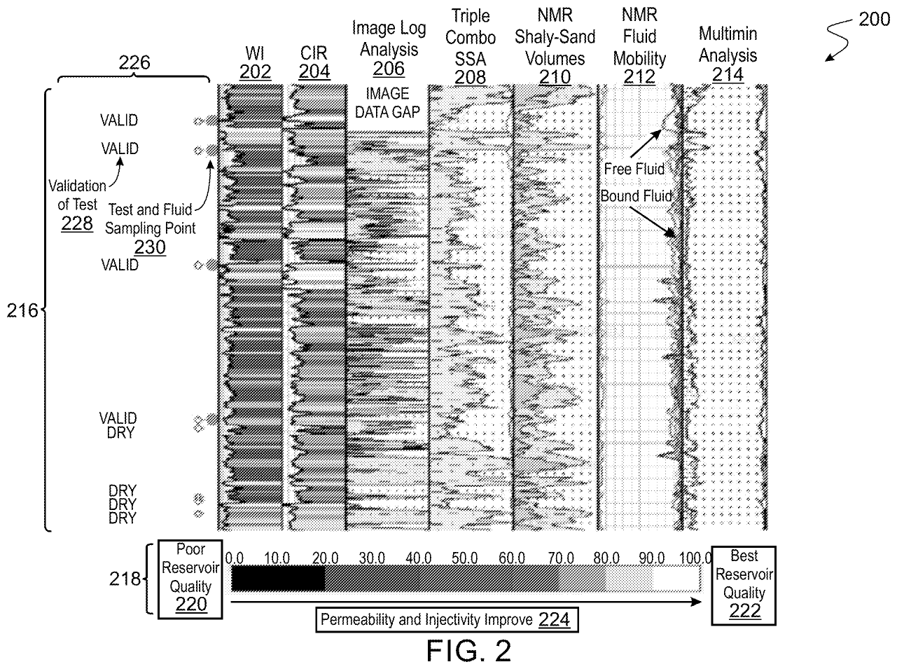

In an example, referring to FIG. 2, at step 214, the petrophysical model for the reservoir is calibrated. At 208, in the independent shaly sand analysis the porosity is calibrated to the porosity from step 214. At 210, the NMR grain size distribution can provide the initial view of layering and lithology percentages, from which facies are specified. The results can be used in 208 for comparison. At 208, in a shaly sand analysis, the density-neutron values for various sand, silt, and quartz properties are acquired from core or mud logs and cutting measurements. The porosity from this SSA can be calibrated to step 214. NMR data from step 208 processing can indicate the percentage of movable fluid. At 206, layers identified in 208 are further refined. At 202 and 204, correlations are made to 214, 208, 210 and 206 to confirm the depth and reservoir quality of identified permeable layer. The five methodologies are now described.

A first model input methodology is a multimin (MM) petrophysical evaluation, which can provide calibrated porosity, water saturation, intrinsic permeability, and mineral volumes. This can be used in software utilizing statistical analysis for petrophysical evaluation that is calibrated to core data. The methodology can use the properties of minerals for each logging response and compute petrophysical parameters. Outputs of the methodology can be used further to provide parameters that are incorporated into subsequent analysis of the next two described types.

A second model input methodology is NMR analysis. NMR data processing can include standardized archival of NMR tool and wellbore information, e.g., saved as curves. Following standard processing procedures, the NMR analysis can provide porosity arrays from multiple Time 1 (T1) or Time 2 (T2) spectrums (logging tool dependent) estimated using multiple bound fluid cutoffs ranging from 1 microsecond to 3000 microseconds. The arrays can be correlated to grain size distribution (e.g., sand, silt, and clay). In addition, NMR analysis can provide the volume of bound versus free fluids. The NMR's sand-silt-shale volumes can be determined to correlate to shaly sand analysis. NMR processing can include standard processing that is accomplished using petrophysical software. Each logging company can advise its own range of data array-acquired T1 and/or T2 (e.g., terms used in NMR data processing). T1 is a relaxation time that is established without accounting for dispersion effects. T2 identifies a dispersions time, which can be also be utilized in fluid identification.

A third model input methodology is shaly sand analysis. This analysis can include examination of the effects of siltstone on model qualification parameters. This is done because silt is known to have adverse effects on permeability and, as a result, reduces productivity. Layers with smaller concentrations (e.g., “fractions”) of siltstone relative to the total matrix have shown a clear trend of higher reservoir productivity. The methodologies of the present disclosure include the use of cut-off values for siltstone concentrations to differentiate productive layers. As an example, if a layer has a silt percentage below 40% of the total matrix, the layer will likely be productive. The results and calibrations of MM and shaly sand can be conducted to ensure consistency in petrophysical parameters outputs.

A fourth model input methodology is resistivity image log analysis. Image logs typically provide a higher resolution than other products, which allows further refinement of layering within the targeted reservoirs. Layering that is based on resistivity images can enable precise determination of layer thickness and depth. Image logs have the highest vertical resolution relative to accurate depth determinations for identifying the thinnest layer possible.

A fifth model input methodology is neutron spectroscopy for rock quality indices. This methodology provides data for elements data in terms of dry weights and oxide weight percentages. Measured element ratios can provide indications of reservoir quality as follows:

$$Chemical Index Ratio ( CIR ) = \frac{{Al}_{2} {O}_{2}}{{Al}_{2} {O}_{2} + {Na}_{2} O + {K}_{2} O + CaO} \times 100 \qquad ( 1 )$$

$$Weathering Index ( WI ) = \frac{Al}{Mg + Ca + K + Na} ; \\ ( rescaled e . g . , from 0 to 100 ) \qquad ( 2 )$$

Experimentation was used to determine that CIR and WI values above 80 have been found to indicate the best reservoir quality in terms of permeability and injectivity.

Multimin analysis can be used to define calibrated porosity and water saturation models. The calibrated porosity from step 102 can be compared to the NMR porosity. At this stage, the bound fluid from NMR and effective porosity from multimin can be calibrated. NMR's shaly sand with the selected bound fluid cutoffs can then be compared to a triple-combo shaly sand evaluation. The effective porosity and quartz volumes from both evaluations can be calibrated. Further refinement of thin layers can be carried out using resistivity images. Correlation based on WI, CIR, porosity, and sand volumes can be performed to meet the assigned cutoffs. For example, the CIR and WI with reservoir qualities between 70 to 100 can be correlated to the layers identified from the previous processes. The presented integrated workflow allows crosschecking between interpretation methods. Further, AI can be used to help in reducing number of data required by selecting the minimum of data or interpretation requirement. In any AI, there is some uncertainty in the results. The level of confidence on the result can depend on the results of the verification process (112).

In some implementations, weighting of the results of the outputs of the methodologies can be used. Calibrated triple combo shaly sand analysis can be used. Sand, silt, and clay volumes can be calibrated to the core's or advanced mud logging's (AML's) XRD/XRF data. The porosity from triple-combo shaly sand porosity can be calibrated to Multimin evaluation. WI and CIR can be used to assist in selecting the rock quality. Image logs can be used to define the thin layers. Once the multimin and triple combo shaly sand analysis are established for a reservoir in an area, standard petrophysical correlation can be used. In some implementations, weights can be determined based on the values of 102e and 102f in step 112. A greater percentage of correlation can result in assigning a greater weight.

Results of the five evaluation techniques can be correlated to the layers. A layer that meets all criteria (e.g., porosity, permeability, bound fluid, silt volumes, quartz volumes, and clay reservoir quality scales between 90 to 100) can be selected as the best candidates for formation tests or completion intervals. If the quality is less than 90, then the risk of success is reduced accordingly for data acquisition or for injecting fluid/fracking in the zone.

Once sufficient data is acquired and calibrated to the success rate for an area, the NMR and image logs can be discarded from the logging. The neutron spectroscopy (NS) can be replaced with AML XRD/XRF or other methodologies. Deficiencies in depth resolution of AML can be corrected using correlation to SGR acquired from standard logging run for depth control. AML allows the estimation of WI and CIR. Eliminating the need for NMR, NS, and resistivity imaging can result in significant cost- and time-saving in data acquisition.

In some implementations, in order to maximize success rates, test intervals, completion proposals, and geosteering can be restricted to zones having reservoir quality scales of 70 or greater. The scales that are used can be adjusted by area or field based on local geological conditions. FIG. 2 and the corresponding description provide a real well example where the planning for pressure data and fluid sampling acquisitions (226) was done utilizing the workflow.

FIG. 2 is a graph 200 showing comparison plots 202-214 associated with multiple methodologies relative to depth 216 and their indications of reservoir quality, according to some implementations of the present disclosure. The plots and methodologies include WI 202, CIR 204, image log analysis 206, triple combo SSA 208, NMR shaly-sand volumes 210, NMR fluid mobility 212, and multimin analysis 214. Information is the graph 200 is shaded relative to a key 218, ranging in shading from a poor reservoir quality 220 to a best reservoir quality 222, over which permeability and injectivity improve 224. Markers 226 relative to depth 216 indicate points such as validations of test 228 and test and fluid sampling points 230. VALID in the validations of test 228 means that the pressure data was successfully acquired and meets the required data quality. TEST and FLUID SAMPLING means that the pressure and fluid sample were successfully acquired. All the above are associated with CIR and WI between 70-100.

A purpose of the present disclosure is to identify permeable thin layers within massive sand. The permeability does not have a direct relation to porosity. Imaging helps in locating the actual depth of thin layers, and CIR and WI help in identifying permeable zones.

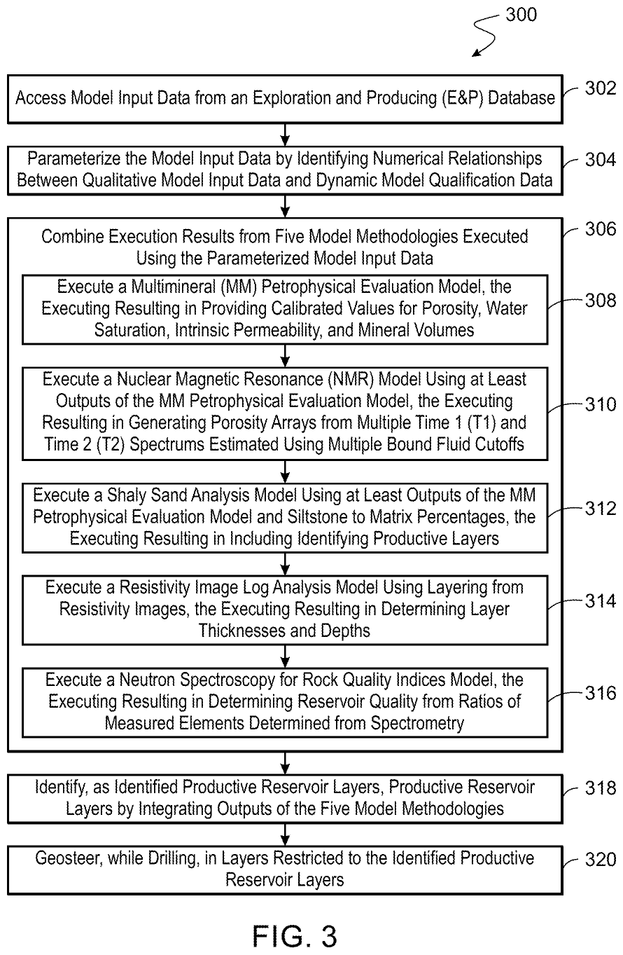

FIG. 3 is a flowchart showing an example of a method 300 for identifying permeable thin layers, according to some implementations of the present disclosure. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, model input data is accessed from an exploration and producing (E&P) database. For example, the model input data can be the retrieved data 102 described with reference to FIG. 102.

In some implementations, method 300 further includes performing a quality assurance and quality control (QA/QC) process on the model input data to ensure consistency and accuracy. Processing can include, for example, comparing tool pre- and post-logging calibration, logging environments, displaying the data, hole condition, comparing the main logs versus the repeat logging run, and correlation with nearby well data. From 302, method 300 proceeds to 304.

At 304, the model input data is parameterized by identifying numerical relationships between qualitative model input data and dynamic model qualification data. In some implementations, parameterizing the model input data can further include: determining, as a determined thickness, thicknesses and depths of targeted thin layers by processing image data of the model input data; and using, based on the determined thicknesses and depths, NMR processing on the model input data to identify grain size distribution and movable versus non-movable fluid volume. For example, parameterization can occur as described with reference to FIGS. 1 and 2. From 304, method 300 proceeds to 306.

At 306, execution results from executing five model methodologies are combined using the parameterized model input data. The executed models are executed in steps 308, 310, 312, 314, and 316. In some implementations, combining execution results of the five model methodologies includes: correlating, as correlated layers, layers determined from the five model methodologies; and determining, from the correlated layers, at least one layer that meets a reservoir quality scale in a threshold range for selecting best candidate layers for formation test or completion intervals. In some implementations, the reservoir quality scale is a function of porosity, permeability, bound fluid, silt volumes, quartz volumes, and clay cutoffs. In some implementations, the threshold range is between 90 to 100. In some implementations, method 300 further includes setting test intervals and restricting completion proposals to layers having a reservoir quality scale between 70 and 100.

At 308, a multimineral (MM) petrophysical evaluation model is executed, the executing resulting in providing calibrated values for porosity, water saturation, intrinsic permeability, and mineral volumes. From 308, method 300 proceeds to 310.

At 310, a nuclear magnetic resonance (NMR) model is executed using at least outputs of the MM petrophysical evaluation model, the executing resulting in generating porosity arrays from multiple Time 1 (T1) and Time 2 (T2) spectrums estimated using multiple bound fluid cutoffs. Multiple cutoffs can be established to correlate the NMR interpretation to core and/or cuttings data. The most correlatable results can be used in the interpretation. From 310, method 300 proceeds to 312.

At 312, a shaly sand analysis model is executed using at least outputs of the MM petrophysical evaluation model and siltstone to matrix percentages, the executing resulting in including identifying productive layers. The MM porosity can serve as the point of calibration when executing the shaly sand analysis. From 312, method 300 proceeds to 314.

At 314, a resistivity image log analysis model is executed using layering from resistivity images, the executing resulting to determine layer thicknesses and depths. Layers can be identified using the highest vertical resolution data. From 314, method 300 proceeds to 316.

At 316, a neutron spectroscopy for rock quality indices model is executed, the executing resulting in determining reservoir quality from ratios of measured elements determined from spectrometry. From 306 and 316, method 300 proceeds to 318.

At 318, productive reservoir layers are identified by integrating outputs of the five model methodologies. For example, the productive reservoir layers can be identified as described with reference to FIG. 2. In general, the five models can be executed in any order, except in the cases in which one model needs inputs that are outputs produced by another model. From 318, method 300 proceeds to 320.

At 320, geosteering, while drilling in layers, is restricted to the identified productive reservoir layers. For example, the geosteering can be restricted to layers corresponding to FIG. 2. Continuous evaluation can occur and be used to restrict the geosteering in the identified layer with CIR and WI between 70 and 100. After 320, method 300 can stop.

The techniques presented by method 300 can be applied in geosteering wells where the NS data from AML is utilized in estimating WI and CIR. These techniques for steering in the well can complement standard petrophysical analysis. Geoscientists can provide input that is used for combining results from multiple wells to upgrade models for subsequent wells.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

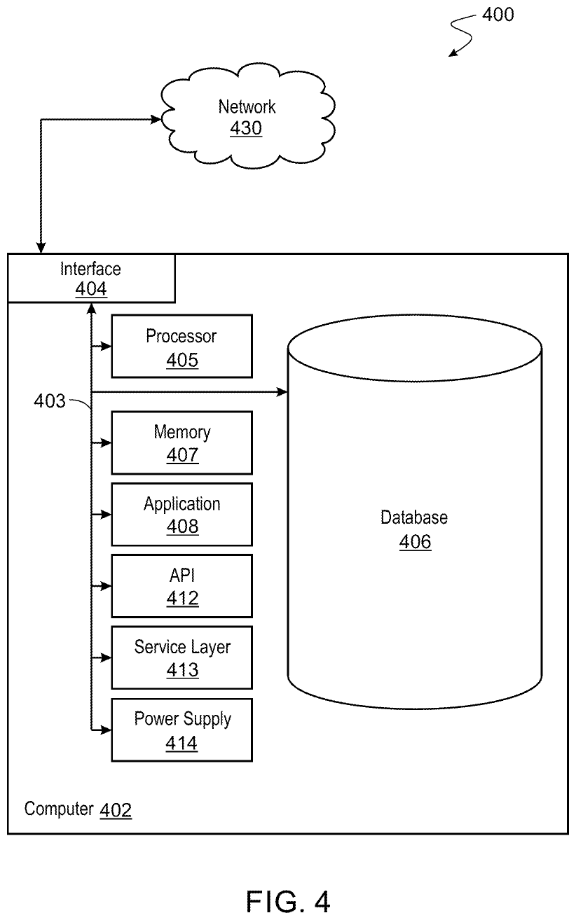

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method includes the following. Model input data is accessed from an exploration and producing (E&P) database. The model input data is parameterized by identifying numerical relationships between qualitative model input data and dynamic model qualification data. Execution results from executing five model methodologies are combined using the parameterized model input data. A multimineral (MM) petrophysical evaluation model is executed, the executing resulting in providing calibrated values for porosity, water saturation, intrinsic permeability, and mineral volumes. A nuclear magnetic resonance (NMR) model is executed using at least outputs of the MM petrophysical evaluation model, the executing resulting in generating porosity arrays from multiple Time 1 (T1) and Time 2 (T2) spectrums estimated using multiple bound fluid cutoffs. A shaly sand analysis model is executed using at least outputs of the MM petrophysical evaluation model and siltstone to matrix percentages, the executing resulting in including identifying productive layers. A resistivity image log analysis model is executed using layering from resistivity images, the executing resulting in determining layer thicknesses and depths. A neutron spectroscopy for rock quality indices model is executed, the executing resulting in determining reservoir quality from ratios of measured elements determined from spectrometry. Productive reservoir layers are identified by integrating outputs of the five model methodologies. Geosteering, while drilling in layers, is restricted to the identified productive reservoir layers.

The foregoing and other described implementations can each, optionally, include one or more of the following features:

A first feature, combinable with any of the following features, where the operations further include performing a quality assurance and quality control (QA/QC) process on the model input data to ensure consistency and accuracy.

A second feature, combinable with any of the previous or following features, where parameterizing the model input data further includes: determining, as a determined thickness, thicknesses and depths of targeted thin layers by processing image data of the model input data; and using, based on the determined thicknesses and depths, NMR processing on the model input data to identify grain size distribution and movable versus non-movable fluid volume.

A third feature, combinable with any of the previous or following features, where combining execution results of the five model methodologies includes: correlating, as correlated layers, layers determined from the five model methodologies; and determining, from the correlated layers, at least one layer that meets a reservoir quality scale in a threshold range for selecting best candidate layers for formation test or completion intervals.

A fourth feature, combinable with any of the previous or following features, where the reservoir quality scale is a function of porosity, permeability, bound fluid, silt volumes, quartz volumes, and clay cutoffs.

A fifth feature, combinable with any of the previous or following features, where the threshold range is between 90 to 100.

A sixth feature, combinable with any of the previous or following features, where the operations further include setting test intervals and restricting completion proposals to layers having a reservoir quality scale between 70 and 100.

In a second implementation, a non-transitory, computer-readable medium stores one or more instructions executable by a computer system to perform operations including the following. Model input data is accessed from an exploration and producing (E&P) database. The model input data is parameterized by identifying numerical relationships between qualitative model input data and dynamic model qualification data. Execution results from executing five model methodologies are combined using the parameterized model input data. A multimineral (MM) petrophysical evaluation model is executed, the executing resulting in providing calibrated values for porosity, water saturation, intrinsic permeability, and mineral volumes. A nuclear magnetic resonance (NMR) model is executed using at least outputs of the MM petrophysical evaluation model, the executing resulting in generating porosity arrays from multiple Time 1 (T1) and Time 2 (T2) spectrums estimated using multiple bound fluid cutoffs. A shaly sand analysis model is executed using at least outputs of the MM petrophysical evaluation model and siltstone to matrix percentages, the executing resulting in including identifying productive layers. A resistivity image log analysis model is executed using layering from resistivity images, the executing resulting in determining layer thicknesses and depths. A neutron spectroscopy for rock quality indices model is executed, the executing resulting in determining reservoir quality from ratios of measured elements determined from spectrometry. Productive reservoir layers are identified by integrating outputs of the five model methodologies. Geosteering, while drilling in layers, is restricted to the identified productive reservoir layers.

The foregoing and other described implementations can each, optionally, include one or more of the following features:

A second feature, combinable with any of the previous or following features, where parameterizing the model input data further includes: determining, as a determined thickness, thicknesses and depths of targeted thin layers by processing image data of the model input data; and using, based on the determined thicknesses and depths, NMR processing on the model input data to identify grain size distribution and movable versus non-movable fluid volume.

A third feature, combinable with any of the previous or following features, where combining execution results of the five model methodologies includes: correlating, as correlated layers, layers determined from the five model methodologies; and determining, from the correlated layers, at least one layer that meets a reservoir quality scale in a threshold range for selecting best candidate layers for formation test or completion intervals.

A fourth feature, combinable with any of the previous or following features, where the reservoir quality scale is a function of porosity, permeability, bound fluid, silt volumes, quartz volumes, and clay cutoffs.

A fifth feature, combinable with any of the previous or following features, where the threshold range is between 90 to 100.

A sixth feature, combinable with any of the previous or following features, where the method further includes setting test intervals and restricting completion proposals to layers having a reservoir quality scale between 70 and 100.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Model input data is accessed from an exploration and producing (E&P) database. The model input data is parameterized by identifying numerical relationships between qualitative model input data and dynamic model qualification data. Execution results from executing five model methodologies are combined using the parameterized model input data. A multimineral (MM) petrophysical evaluation model is executed, the executing resulting in providing calibrated values for porosity, water saturation, intrinsic permeability, and mineral volumes. A nuclear magnetic resonance (NMR) model is executed using at least outputs of the MM petrophysical evaluation model, the executing resulting in generating porosity arrays from multiple Time 1 (T1) and Time 2 (T2) spectrums estimated using multiple bound fluid cutoffs. A shaly sand analysis model is executed using at least outputs of the MM petrophysical evaluation model and siltstone to matrix percentages, the executing resulting in including identifying productive layers. A resistivity image log analysis model is executed using layering from resistivity images, the executing resulting in determining layer thicknesses and depths. A neutron spectroscopy for rock quality indices model is executed, the executing resulting in determining reservoir quality from ratios of measured elements determined from spectrometry. Productive reservoir layers are identified by integrating outputs of the five model methodologies. Geosteering, while drilling in layers, is restricted to the identified productive reservoir layers.

The foregoing and other described implementations can each, optionally, include one or more of the following features:

A first feature, combinable with any of the following features, where the operations further include performing a quality assurance and quality control (QA/QC) process on the model input data to ensure consistency and accuracy.

A second feature, combinable with any of the previous or following features, where parameterizing the model input data further includes: determining, as a determined thickness, thicknesses and depths of targeted thin layers by processing image data of the model input data; and using, based on the determined thicknesses and depths, NMR processing on the model input data to identify grain size distribution and movable versus non-movable fluid volume.

A third feature, combinable with any of the previous or following features, where combining execution results of the five model methodologies includes: correlating, as correlated layers, layers determined from the five model methodologies; and determining, from the correlated layers, at least one layer that meets a reservoir quality scale in a threshold range for selecting best candidate layers for formation test or completion intervals.

A fourth feature, combinable with any of the previous or following features, where the reservoir quality scale is a function of porosity, permeability, bound fluid, silt volumes, quartz volumes, and clay cutoffs.

A fifth feature, combinable with any of the previous or following features, where the threshold range is between 90 to 100.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access and/or interact with the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
accessing model input data from an exploration and producing (E&P) database;
parameterizing the model input data by identifying numerical relationships between qualitative model input data and dynamic model qualification data;
combining execution results from five model methodologies executed using the parameterized model input data, including:
executing a multimineral (MM) petrophysical evaluation model, the executing resulting in providing calibrated values for porosity, water saturation, intrinsic permeability, and mineral volumes;
executing a nuclear magnetic resonance (NMR) model using at least outputs of the MM petrophysical evaluation model, the executing resulting in generating porosity arrays from multiple Time 1 (T1) and Time 2 (T2) spectrums estimated using multiple bound fluid cutoffs;
executing a shaly sand analysis model using at least outputs of the MM petrophysical evaluation model and siltstone to matrix percentages, the executing resulting in including identifying productive layers;
executing a resistivity image log analysis model using layering from resistivity images, the executing resulting in determining layer thicknesses and depths; and
executing a neutron spectroscopy for rock quality indices model, the executing resulting in determining reservoir quality from ratios of measured elements determined from spectrometry;
identifying, as identified productive reservoir layers, productive reservoir layers by integrating outputs of the five model methodologies; and
geosteering, while drilling, in layers restricted to the identified productive reservoir layers.

2. The computer-implemented method of claim 1, further comprising:
performing a quality assurance and quality control (QA/QC) process on the model input data to ensure consistency and accuracy.

3. The computer-implemented method of claim 1, wherein parameterizing the model input data further includes:
determining, as a determined thickness, thicknesses and depths of targeted thin layers by processing image data of the model input data; and
using, based on the determined thicknesses and depths, NMR processing on the model input data to identify grain size distribution and movable versus non-movable fluid volume.

4. The computer-implemented method of claim 1, wherein combining execution results of the five model methodologies includes:
correlating, as correlated layers, layers determined from the five model methodologies; and
determining, from the correlated layers, at least one layer that meets a reservoir quality scale in a threshold range for selecting best candidate layers for formation test or completion intervals.

5. The computer-implemented method of claim 4, wherein the reservoir quality scale is a function of porosity, permeability, bound fluid, silt volumes, quartz volumes, and clay cutoffs.

6. The computer-implemented method of claim 4, wherein the threshold range is between 90 to 100.

7. The computer-implemented method of claim 4, further comprising:
setting test intervals and restricting completion proposals to layers having a reservoir quality scale between 70 and 100.

8. A non-transitory, computer-readable medium storing one or more instructions executable by a computer system to perform operations comprising:
accessing model input data from an exploration and producing (E&P) database;
parameterizing the model input data by identifying numerical relationships between qualitative model input data and dynamic model qualification data;
combining execution results from five model methodologies executed using the parameterized model input data, including:
executing a multimineral (MM) petrophysical evaluation model, the executing resulting in providing calibrated values for porosity, water saturation, intrinsic permeability, and mineral volumes;
executing a nuclear magnetic resonance (NMR) model using at least outputs of the MM petrophysical evaluation model, the executing resulting in generating porosity arrays from multiple Time 1 (T1) and Time 2 (T2) spectrums estimated using multiple bound fluid cutoffs;
executing a shaly sand analysis model using at least outputs of the MM petrophysical evaluation model and siltstone to matrix percentages, the executing resulting in including identifying productive layers;
executing a resistivity image log analysis model using layering from resistivity images, the executing resulting in determining layer thicknesses and depths; and
executing a neutron spectroscopy for rock quality indices model, the executing resulting in determining reservoir quality from ratios of measured elements determined from spectrometry;
identifying, as identified productive reservoir layers, productive reservoir layers by integrating outputs of the five model methodologies; and
geosteering, while drilling, in layers restricted to the identified productive reservoir layers.

9. The non-transitory, computer-readable medium of claim 8, the operations further comprising:
performing a quality assurance and quality control (QA/QC) process on the model input data to ensure consistency and accuracy.

10. The non-transitory, computer-readable medium of claim 8, wherein parameterizing the model input data further includes:
determining, as a determined thickness, thicknesses and depths of targeted thin layers by processing image data of the model input data; and
using, based on the determined thicknesses and depths, NMR processing on the model input data to identify grain size distribution and movable versus non-movable fluid volume.

11. The non-transitory, computer-readable medium of claim 8, wherein combining execution results of the five model methodologies includes:
correlating, as correlated layers, layers determined from the five model methodologies; and
determining, from the correlated layers, at least one layer that meets a reservoir quality scale in a threshold range for selecting best candidate layers for formation test or completion intervals.

12. The non-transitory, computer-readable medium of claim 11, wherein the reservoir quality scale is a function of porosity, permeability, bound fluid, silt volumes, quartz volumes, and clay cutoffs.

13. The non-transitory, computer-readable medium of claim 11, wherein the threshold range is between 90 to 100.

14. The non-transitory, computer-readable medium of claim 11, the operations further comprising:
setting test intervals and restricting completion proposals to layers having a reservoir quality scale between 70 and 100.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
accessing model input data from an exploration and producing (E&P) database;
parameterizing the model input data by identifying numerical relationships between qualitative model input data and dynamic model qualification data;
combining execution results from five model methodologies executed using the parameterized model input data, including:
executing a multimineral (MM) petrophysical evaluation model, the executing resulting in providing calibrated values for porosity, water saturation, intrinsic permeability, and mineral volumes;
executing a nuclear magnetic resonance (NMR) model using at least outputs of the MM petrophysical evaluation model, the executing resulting in generating porosity arrays from multiple Time 1 (T1) and Time 2 (T2) spectrums estimated using multiple bound fluid cutoffs;
executing a shaly sand analysis model using at least outputs of the MM petrophysical evaluation model and siltstone to matrix percentages, the executing resulting in including identifying productive layers;
executing a resistivity image log analysis model using layering from resistivity images, the executing resulting in determining layer thicknesses and depths; and
executing a neutron spectroscopy for rock quality indices model, the executing resulting in determining reservoir quality from ratios of measured elements determined from spectrometry;
identifying, as identified productive reservoir layers, productive reservoir layers by integrating outputs of the five model methodologies; and
geosteering, while drilling, in layers restricted to the identified productive reservoir layers.

16. The computer-implemented system of claim 15, the operations further comprising:
performing a quality assurance and quality control (QA/QC) process on the model input data to ensure consistency and accuracy.

17. The computer-implemented system of claim 15, wherein parameterizing the model input data further includes:
determining, as a determined thickness, thicknesses and depths of targeted thin layers by processing image data of the model input data; and
using, based on the determined thicknesses and depths, NMR processing on the model input data to identify grain size distribution and movable versus non-movable fluid volume.

18. The computer-implemented system of claim 15, wherein combining execution results of the five model methodologies includes:
correlating, as correlated layers, layers determined from the five model methodologies; and
determining, from the correlated layers, at least one layer that meets a reservoir quality scale in a threshold range for selecting best candidate layers for formation test or completion intervals.

19. The computer-implemented system of claim 18, wherein the reservoir quality scale is a function of porosity, permeability, bound fluid, silt volumes, quartz volumes, and clay cutoffs.

20. The computer-implemented system of claim 18, wherein the threshold range is between 90 to 100.
